(19) United States
(12) Patent Application Publication
(10) Pub. No.: US 2007/0005764 A1
(43) Pub. Date: Jan. 4, 2007

(54) NETWORK AND METHOD FOR IMPLEMENTING ONLINE CREDIT CONTROL FOR A TERMINAL

(76) Inventor: Patrik Teppo, Jamjo (SE)

Correspondence Address: ERICSSON INC., 6300 LEGACY DRIVE, M/S EVR C11, PLANO, TX, 75024, US

(21) Appl. No.: 11/424,701

(22) Filed: Jun. 16, 2006

Related U.S. Application Data
(60) Provisional application No. 60/695,082, filed on Jun. 29, 2005.

(51) Int. Cl. G06F 15/173; G06F 15/16

(52) U.S. Cl. 709/225; 709/227

(57) ABSTRACT

A network (e.g., 3GPP network) is described herein which includes an AAA server that uses an authentication functionality to enable an access node (associated with an access network) to implement online credit control for a terminal when the access node (e.g., WLAN access node) supports the existing RADIUS/Diameter protocol but does not support a Diameter Credit Control Application (or similar application like RADIUS Prepaid).

### CROSS-REFERENCE TO RELATED APPLICATIONS

This application claims the benefit of U.S. Provisional Application Ser. No. 60/695,082 filed on Jun. 29, 2005 and entitled “Adding Message Flows for Wf and Wo Referense Point”. The contents of this document are incorporated by reference herein.

### STATEMENT REGARDING FEDERALLY SPONSORED RESEARCH OR DEVELOPMENT

NOT APPLICABLE

### REFERENCE TO SEQUENCE LISTING, A TABLE, OR A COMPUTER PROGRAM LISTING COMPACT DISC APPENDIX

NOT APPLICABLE

### BACKGROUND OF THE INVENTION

1. Field of the Invention

The present invention relates to a network and a method for implementing online credit control (e.g. for prepaid access) so that a service can be rated and a subscriber charged or credit controlled before they can use a terminal to access the service. In one embodiment, the network (e.g., 3GPP network) includes an AAA server which uses an authentication functionality to enable an access server (associated with an access network) to implement online credit control for a terminal. In this embodiment, the access server (e.g., WLAN access server) supports the existing RADIUS/Diameter protocol but it does not support a Diameter Credit Control Application (or a similar application like RADIUS Prepaid).

2. Description of Related Art

The following abbreviations are herewith defined, at least some of which are referred to in the ensuing description of the prior art and the preferred embodiments of the present invention.

3GPP 3^{rd} Generation Partnership Project

AAA Authentication, Authorization and Accounting

ACA Accounting Credit Response

ACR Accounting Control Request

AN Access Node

CCA Credit Control Authorization

CCR Credit Control Request

DCC Diameter Credit Control

GPRS General Package Radio Services

GSM Global System for Mobile Communications

IETF Internet Engineering Task Force

LAN Local Area Network

MMS Multimedia Messaging Service

OCS Online Charging System

RADIUS Remote Authentication Dial in User Service

RFC Request for Comments

SMS Short Message Service

UE User Equipment

UMTS Universal Mobile Telecommunications System

Wo Reference point between a 3GPP AAA Server and an OCS

WLAN Wireless LAN

Referring to FIG. 1 (PRIOR ART), there is shown a block diagram of a traditional GSM/UMTS core network charging architecture 100 that is used to help explain an online credit control problem which is solved by the present invention. As shown, the traditional GSM/UMTS core network charging architecture 100 has an access network 102 (e.g., WLAN access network 102) which includes a terminal 104 (e.g., WLAN UE

104)(one shown) and an access node 106 (e.g., WLAN access node 106). In addition, the traditional GSM/UMTS core network charging architecture 100 has a 3GPP network 108 which includes an AAA server 110 and an OCS 112. For clarity, only the components associated with the traditional GSM/UMTS core network charging architecture 100 which are needed to discuss the present invention are illustrated and described herein.

As shown, this third-generation (3G) wireless system 100 implements a charging solution by utilizing the well known RADIUS/Diameter protocols (see IETF RFC 2138 “RADIUS” and IETF RFC 3588 “DIAMETER”) to authenticate subscribers, authorize service and charge the subscriber. Basically, the Diameter protocol provides an Authentication, Authorization and Accounting (AAA) framework for applications such as network access or IP mobility. And, the Diameter base protocol provides the minimum requirements needed for a AAA protocol. The base protocol may be used by itself for accounting purposes only, or it may be used with a Diameter application. However, the accounting part of the RADIUS/Diameter protocol is not an online interface which means that a service can not be rated and the subscriber can not be charged before they access the service. In other words, the subscriber can not use a real time prepaid solution so they can pay in advance for a service and then later access and use a particular service. To address this problem, a Diameter Credit Control (DCC) Application has been implemented to enable the online credit control for a subscriber. This works well if the access node supports both the RADIUS/Diameter protocol and the DCC Application. But, there are many legacy-type access nodes like WLAN access node 106 which do support the existing RADIUS/Diameter protocol but do not support the DCC application and as a result these access nodes can not implement online credit control for the subscriber.

A second way this problem can be address was discussed in the co-assigned PCT Patent Application WO 02/067498 A1 entitled “Prepaid Access to Internet Protocol (IP) Networks”. This particular solution required that the RADIUS protocol be changed so that new information associated with online credit control can be sent on the RADIUS interface between the access node and the AAA server. The access node if properly configured could then use this new information to monitor the subscriber's usage of a service and also re-authorize or stop the subscriber's usage of the service. This particular solution which is known as RADIUS Prepaid works well if the access node supports the new extension. However, there are still many legacy type access nodes like WLAN access node 106 which do not support this RADIUS Prepaid extension and as a result these access nodes can not implement online credit control for the subscriber. Hence, there is a need for a prepaid online credit control solution which can be used by a legacy WLAN access node 106 that supports the existing RADIUS/Diameter protocol but does not support a DCC application (or a similar application like RADIUS Prepaid). This need and other needs are addressed by the present invention.

### BRIEF SUMMARY OF THE INVENTION

The present invention relates to a network (e.g., 3GPP network) which includes an AAA server that uses an authentication functionality to enable an access node (associated with an access network) to implement online credit control for a terminal when the access node (e.g., WLAN access node) supports the existing RADIUS/Diameter protocol but does not support a Diameter Credit Control Application (or similar application like RADIUS Prepaid). Basically, the AAA server utilizes an authentication functionality in a different manner than is defined by the existing RADIUS/Diameter protocol so that the access node can support online credit control and enable the subscriber to use a prepaid account to access a service. In particular, the AAA server receives a service request from the access node indicating that the subscriber wants to access a service. Then, the AAA server interfaces with an external OCS (or an integrated OCS) which rates the service and reserves a quota in the form of time (seconds). Thereafter, the AAA server replies to the access node with an authentication signal containing a session-timeout parameter (which is directly related to the reserved quota) and a termination action parameter (which requires the access node to make a new request when the session time-out is reached). This authentication signal enables the access node to support online credit control so the subscriber can use a prepaid account (managed by the OCS) to access the service.

### BRIEF DESCRIPTION OF THE SEVERAL VIEWS OF THE DRAWING

A more complete understanding of the present invention may be had by reference to the following detailed description when taken in conjunction with the accompanying drawings wherein:

FIG. 1 (PRIOR ART) is a block diagram of a traditional GSM/UMTS core network charging architecture that is used to help explain an online credit control problem which will be solved by the present invention;

FIG. 2 is a block diagram of a GSM/UMTS core network charging architecture which is used to help explain how the problem associated with providing online credit control is solved by the present invention;

FIG. 3 is a signal flow diagram that illustrates the basic steps for implementing an online credit control between an AAA server and a legacy access node (e.g., WLAN access node) in accordance with a first embodiment of the present invention;

FIG. 4 is a signal flow diagram that illustrates the basic steps for implementing an online credit control between an AAA server and a legacy access node (e.g., WLAN access node) in accordance with a second embodiment of the present invention; and

FIG. 5 is a signal flow diagram that illustrates the basic steps for implementing an online credit control between an AAA server and a legacy access node (e.g., WLAN access node) in accordance with a third embodiment of the present invention.

### DETAILED DESCRIPTION OF THE INVENTION

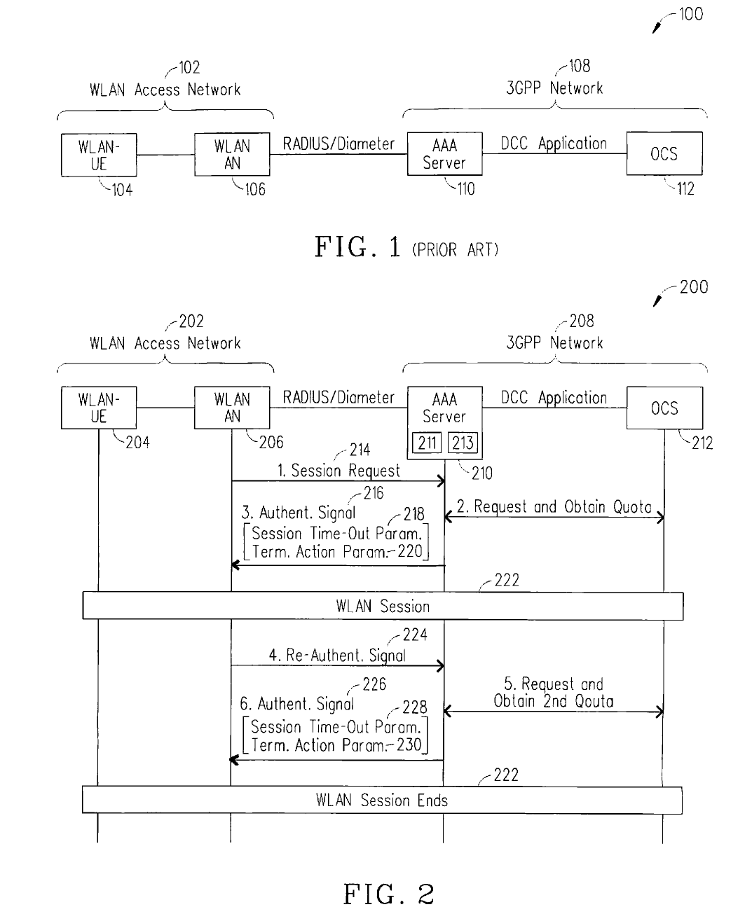

Referring to FIG. 2, there is shown a block diagram of a GSM/UMTS core network charging architecture 200 which is used to help explain how the problem associated with providing an online credit control is solved by the present invention. As shown, the GSM/UMTS core network charging architecture 200 has an access network 202 (e.g., WLAN access network 202) which includes a terminal 204 (e.g. WLAN UE 204)(one shown) and an access node 206 (e.g., WLAN access node 206). In this discussion, the WLAN access server 206 is assumed to be able to support the existing RADIUS/Diameter protocol but is not able to support a DCC Application (or similar application like RADIUS Prepaid). The GSM/UMTS core network charging architecture 200 also has a 3GPP network 208 which includes an AAA server 210 and an OCS 212. The components 202, 204, 206, 208, 210 and 212 are the same as the components 102, 104, 106, 108, 110 and 112 shown in FIG. 1 (PRIOR ART) except that the AAA server 210 has been enhanced to use its authentication functionality to enable the legacy WLAN access node 206 to implement online credit control (prepaid access) for the terminal 204.

The enhanced AAA server 210 includes a processor 211 that processes instructions stored within a memory 213 to be able to function as follows: (1) receive a signal 214 from the legacy WLAN access node 206 indicating that a subscriber using terminal 204 wants to access a session (see step 1); (2) interact with the external OCS 212 (or integrated OCS 212) which determines a quota related to an allowed service usage for the terminal 204 (see step 2); and (3) send an authentication signal 216 to the legacy WLAN access node 206 (see step 3). The authentication signal 216 is not a typical authentication signal because it contains a session time-out parameter 218 (which is based on the quota) and a termination action parameter 220 (which indicates that the legacy WLAN access node 206 needs to either terminate the session 222 or initiate a re-authentication request after exceeding a predetermined amount of time set by the session time-out parameter 218). Upon receiving the authentication signal 216, the WLAN access node 206 enables the terminal 204 to the access the service.

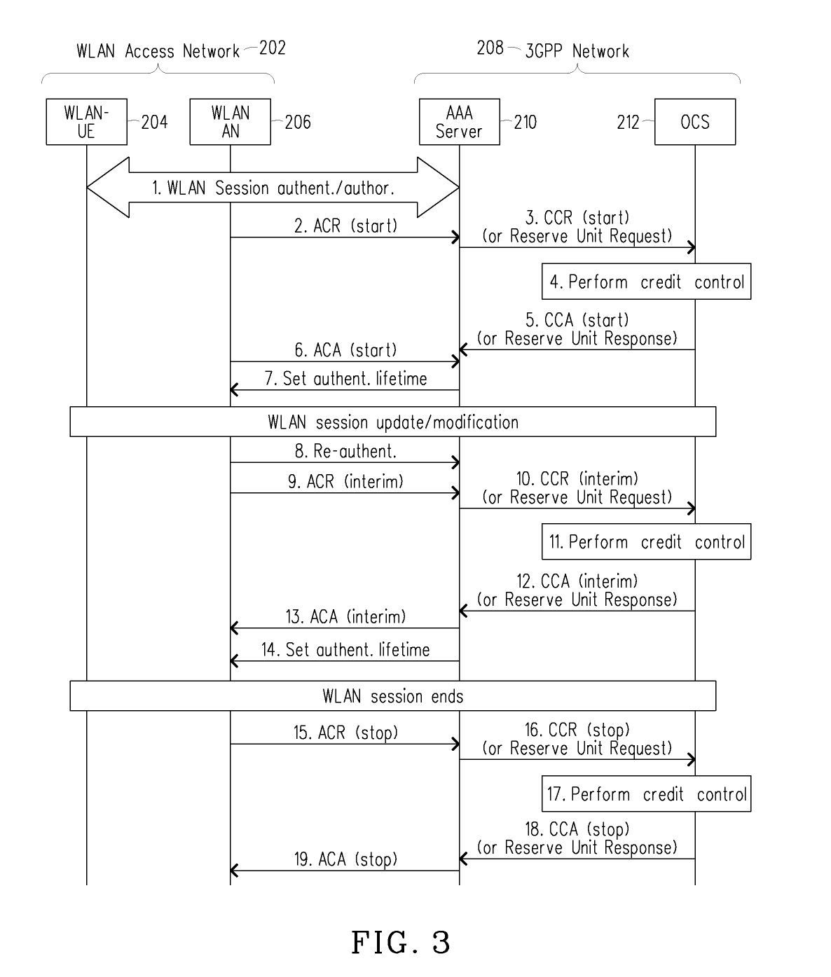

Once the time associated with the session time-out parameter 218 expires and the subscriber still wants to continue the session 222, then the legacy WLAN access node 206 needs to send a re-authentication signal 224 (pursuant to the termination action parameter 218) towards the AAA server 210. Thereafter, the AAA server 210 functions to: (4) receive the re-authentication request signal 224 from the legacy WLAN access node 206 (see step 4); (5) interact with the OCS 212 which determines a second quota related to the remaining allowed service usage for the terminal 204 (see step 5); and (6) send a second authentication signal 226 to the legacy WLAN access node 206 (see step 6). The second authentication signal 226 contains a session time-out parameter 228 (which is based on the second quota) and a termination action parameter 230 (which indicates that the legacy WLAN access node 206 needs to either terminate the session 222 or initiate a second re-authentication request after exceeding a predetermined amount of time set by the session time-out parameter 226). It should be noted that steps 4-6 can be repeated as many times as needed so long as there is enough credit in the subscribers prepaid account (which is located in the OSC 212). However, in this example, the terminal 204 (or other party) discontinued the session 222 before another re-authentication signal would be needed to be sent to the AAA server 210. A detailed discussion about three different ways that the AAA server 210 (and the OSC 212) can function in accordance with the present invention are described below with respect to the signal flow diagrams shown in FIGS. 3-5.

Referring to FIG. 3, there is a signal flow diagram that illustrates the basic steps for implementing online credit control between the AAA server 210 and the legacy WLAN access node 206 in accordance with a first embodiment of the present invention. In this embodiment, it is assumed that the WLAN access node 206 supports the accounting functionality of the RADIUS/Diameter protocol. The steps are as follows:
1. The WLAN UE 204 (terminal 204) requests a WLAN session (see step 1 in FIG. 2).
2. The WLAN access node 206 starts an accounting session with the 3GPP AAA server 210 by sending an ACR to the 3GPP AAA server 210.
3. The 3GPP MA server 210 sends a CCR (or Reserve Unit Request message) to the OCS 212 (see step 2 in FIG. 2).
4. The OCS 212 performs credit control (rating/reservation of quota)(see step 2 in FIG. 2).
5. The OCS 212 replies with a CCA (or Reserve Unit Response message) with a quota (if granted by the OCS 212)(see step 2 in FIG. 2).
6. The 3GPP MA server 210 acknowledges the accounting session with the WLAN access network 202 by sending an ACA to the WLAN AN 206.
7. The 3GPP AAA server 210 sends an authentication signal 216 to the WLAN AN 206 after setting the session timeout 218 (and setting the termination action 220 to new request) for the WLAN session 222 based on the time quota assigned by the OCS 212 (see step 3 in FIG. 2).
8. The WLAN access node 206 re-authenticates when the timeout has expired by sending a re-authentication signal 224 to the 3GPP MA server 210 (see step 4 in FIG. 2).
9. The WLAN access node 206 sends an interim ACR to the 3GPP AAA server 210.
10. Based on the interim ACR and the re-authentication messages, the 3GPP AAA server 210 prepares a new CCR (or Reserve Unit Request message) and sends it to the OCS 212 (see step 5 in FIG. 2).
11. The OCS 212 performs credit control (rating/reservation of quota)(see step 5 in FIG. 2).
12. The OCS 212 replies with an interim CCA (or Reserve Unit Response message) with a quota (if granted by OCS 212)(see step 5 in FIG. 2).
13. The 3GPP AAA server 210 acknowledges the accounting session to WLAN access network 202 by sending an interim ACA to the WLAN AN 206.
14. The 3GPP AAA server 210 sends an authentication signal 226 to the WLAN AN 206 after setting the session timeout 228 (and setting the termination action 230 to new request) for the WLAN session 222 based on the second time quota assigned by the OCS 212 (see step 6 in FIG. 2).
15. When the WLAN session ends, then the WLAN access node 206 sends an ACR (stop) to the 3GPP AAA server 210.
16. The 3GPP AAA server 210 prepares a CCR (or Reserve Unit Request message) with information from the ACR and sends it to the OCS 212.
17. The OCS 212 performs credit control (updates the account/return back unused quota).
18. The OCS 212 send a CCA (or Reserve Unit Response message) to the 3GPP AAA server 210.
19. The 3GPP AAA server 210 acknowledges the end of the accounting session by sending an ACA (stop) to the WLAN access node 206.

This procedure is shown where the quota is based on time (in this case the credit risk could be decreased if small time reservations are used). However, the quota can also be based on a unit other than pure time, like volume or a combination of time/volume. In this case, the OCS 212 delivers a quota in e.g. volume or time/volume which is transformed by the AAA server 210 and given as a time value (in the auth. lifetime—see step 7) to the WLAN AN 206. The WLAN AN 206 then reports the used volume/time within the ACR (see step 9) to the AAA server 210. The AAA server 210 can then transfer the used volume/time in the CCR (see step 10) to the OCS 212 for rating/deduction (as discussed above). However, the AAA server 210 can also make use of this information itself to regulate the transformation function. For instance, in step 7 the transformation is initially AuthLifetime:=Quota(Mbytes)*20 seconds but since the used volume in step 9 is only for example half of the received quota the formula is changed to AuthLifetime:=Quota(Mbytes)*40 seconds.

Moreover, there can be more than one interim DCC (or similar) transaction (see steps 10-12) for a WLAN session 222. And, the OCS 212 can define the interim report interval when it sets the reserved quota.

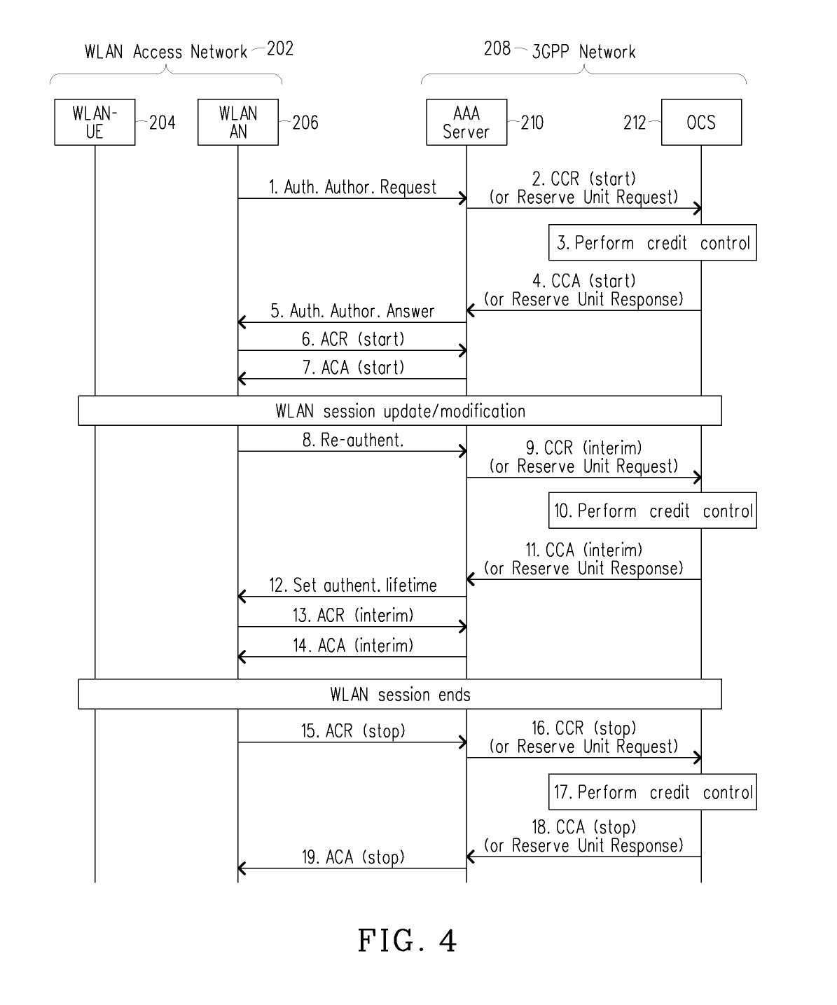

Referring to FIG. 4, there is a signal flow diagram that illustrates the basic steps for implementing online credit control between the AAA server 210 and the legacy WLAN access node 206 in accordance with a second embodiment of the present invention. In this embodiment, it is assumed that the WLAN access node 206 supports the accounting functionality of the RADIUS/Diameter protocol. The steps are as follows:
1. The WLAN access network 202 starts authentication/authorization with the 3GPP AAA server 210 (see step 1 in FIG. 2).
2. The 3GPP AAA server 210 sends a CCR (or Reserve Unit Request message) to the OCS 212 (see step 2 in FIG. 2).
3. The OCS 212 performs credit control (rating/reservation of quota)(see step 2 in FIG. 2).
4. The OCS 212 replies with a CCA (or Reserve Unit Response message) with a quota (if granted by the OCS 212)(see step 2 in FIG. 2).
5. The 3GPP AAA server 210 sends the WLAN access network 202 an authentication/authorization signal 216 which contains a session timeout 218 (and termination action 220 set to new request) based on the reserved quota (see step 3 in FIG. 2).
6. The WLAN access node 206 starts an accounting session by sending an ACR to the 3GPP AAA server 210.
7. The 3GPP AAA server 210 acknowledges the accounting session with the WLAN access network 202 by sending an ACA to the WLAN AN 206.
8. The WLAN access node 206 re-authenticates when the session-timeout has expired by sending a re-authentication signal 224 to the 3GPP AAA server 210 (see step 4 in FIG. 2).
9. Based on the re-authentication message, the 3GPP AAA server 210 prepares an interim CCR (or Reserve Unit Request message) and sends it to the OCS 212 (see step 5 in FIG. 2).
10. The OCS 212 performs credit control (rating/reservation of quota)(see step 5 in FIG. 2).
11. The OCS 212 replies with an interim CCA (or Reserve Unit Response message) with a quota (if granted by the OCS 212)(see step 5 in FIG. 2).
12. The 3GPP AAA server 210 sends an authentication signal 226 to the WLAN AN 206 after setting the session timeout 228 (and setting the termination action 230 to new request) for the WLAN session 222 based on the second time quota assigned by the OCS 212 (see step 6 in FIG. 2).
13. The WLAN access node 206 sends an interim ACA to the 3GPP AAA server 210.
14. The 3GPP AAA server 210 acknowledges the accounting message by sending an interim ACA to the WLAN AN 206.
15. When the WLAN session ends, then WLAN access node 206 sends an ACR (stop) to the 3GPP AAA server 210.
16. The 3GPP AAA server 210 prepares a CCR (or Reserve Unit Request message) with information from the ACR and sends it to the OCS 212.
17. The OCS 212 performs credit control (updates the account/return back unused quota).
18. The OCS 212 acknowledges by sending a CCA (or Reserve Unit Response message) to the 3GPP AAA server 210.
19. The 3GPP AAA server 210 acknowledges the end of the accounting session by sending an ACA (stop) to the WLAN AN 206.

This solution is shown as supporting full credit control when charging is based on time. Note: charging based on volume is not possible in this scenario.

There can be more than one interim DCC (or similar) transaction (see steps 9-11) for a WLAN session 222. And, the OCS 212 can define the interim report interval when it sets the reserved quota.

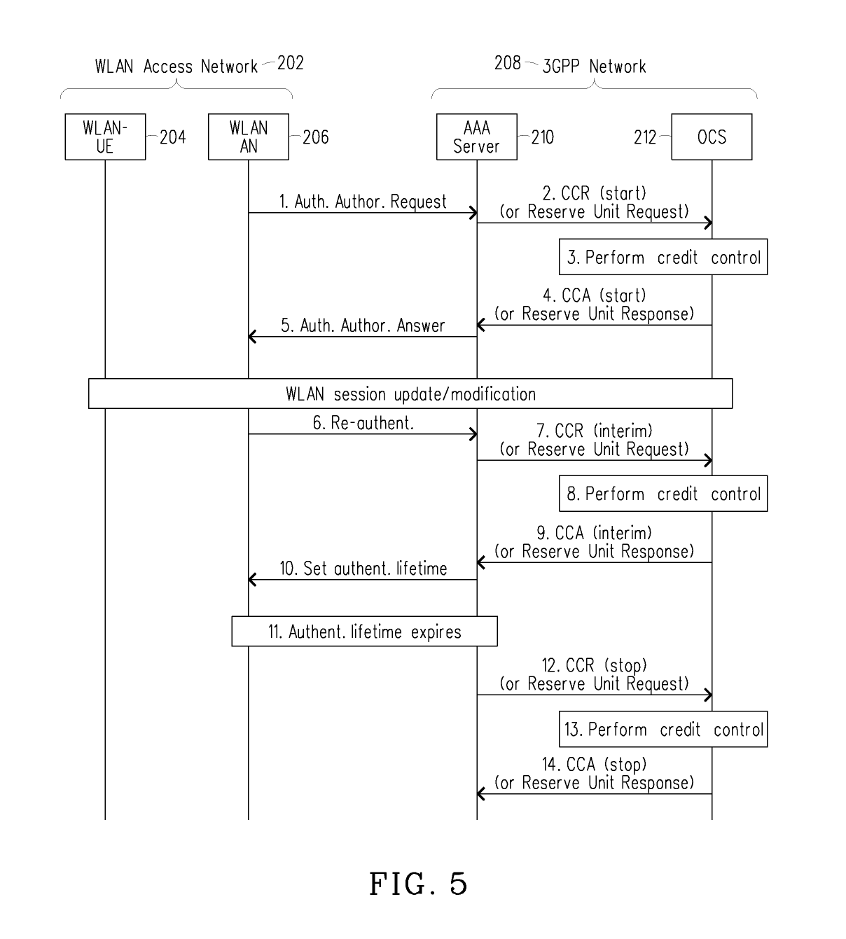

Referring to FIG. 5, there is a signal flow diagram that illustrates the basic steps for implementing online credit control between the AAA server 210 and the legacy WLAN access node 206 in accordance with a third embodiment of the present invention. In this embodiment, it is assumed that the WLAN access node 206 does not support the accounting functionality of the RADIUS/Diameter protocol. The steps are as follows:
1. The WLAN access network 202 starts authentication/authorization with the 3GPP AAA server 210 (see step 1 in FIG. 2).
2. The 3GPP AAA server 210 sends a CCR (or Reserve Unit Request message) to the OCS 212 (see step 2 in FIG. 2).
3. The OCS 212 performs credit control (rating/reservation of quota)(see step 2 in FIG. 2).
4. The OCS 212 replies with a CCA (or Reserve Unit Response message) with a quota (if granted by the OCS 212)(see step 2 in FIG. 2).
5. The 3GPP AAA server 210 sends the WLAN access network 202 an authentication/authorization signal 216 which contains a session timeout 218 (and termination action 220 set to new request) based on the reserved quota (see step 3 in FIG. 2).
6. The WLAN access node 206 re-authenticates when the session-timeout has expired by sending a re-authentication signal 224 to the 3GPP AAA server 210 (see step 4 in FIG. 2).
7. Based on the re-authentication message, the 3GPP AAA server 210 prepares an interim CCR (or Reserve Unit Request message) and sends it to the OCS 212 (see step 5 in FIG. 2).
8. The OCS 212 performs credit control (rating/reservation of quota)(see step 5 in FIG. 2).
9. The OCS 212 replies with an interim CCA (or Reserve Unit Response message) with a quota (if granted by the OCS 212)(see step 5 in FIG. 2).
10. The 3GPP AAA server 210 sends an authentication signal 226 to the WLAN AN 206 after setting the session timeout 228 (and setting the termination action 230 to new request) for the WLAN session 222 based on the second time quota assigned by the OCS 212 (see step 6 in FIG. 2).
11. When the authentication timeout expires and no new re-authentication has been performed, then the WLAN session 222 will be handled as closed.
12. The 3GPP AAA server 210 prepares a CCR stop (or Reserve Unit Request message) with used units as the authentication timeout, and sends it to OCS 212.
13. The OCS 212 performs credit control (updates the account/return back unused quota).
14. The OCS 212 sends a CCA stop (or Reserve Unit Response message) as acknowledgement to the 3GPP MA server 210.

This solution supports full credit control when charging is based on time. However, the WLAN user can be over-charged because the OCS 212 stops charging when the last re-authentication timeout has expired. This needs to happen because the 3GPP AAA server 210 and OCS 212 never know exactly when the WLAN session 222 ends.

There can be more than one interim DCC (or similar) transaction (see steps 7-9) for a WLAN session. And, the OCS 212 can define the interim report interval when it sets the reserved quota.

From the foregoing, it should be appreciated that the present invention uses the existing authentication lifetime functionality in RADIUS to enable online charging. In the past, the authentication lifetime functionality was used to get the terminal 204 to re-authenticate within a defined interval so that the AAA server 210 can control the authentication lifetime. However, the present invention uses the authentication lifetime functionality for online credit control. In particular, the present invention uses the authentication lifetime to grant usage for a defined time based on credit within the subscriber's prepaid account. Thus, a reservation is done on the prepaid account for a defined time period and this is sent back to the legacy access node 206 (e.g., WLAN access node 206) in the authentication lifetime parameter. And, when this lifetime expires, the legacy access node 206 needs to re-authenticate to get a new lifetime. Then, the subscriber's account is deducted with the used time and a new reservation is done for a new lifetime.

Although several embodiments of the present invention have been illustrated in the accompanying Drawings and described in the foregoing Detailed Description, it should be understood that the invention is not limited to the embodiments disclosed, but is capable of numerous rearrangements, modifications and substitutions without departing from the spirit of the invention as set forth and defined by the following claims.

What is claimed is:

1. An AAA server, comprising:
a processor;
a memory; and
instructions accessible from said memory and processable by said processor to facilitate:
receiving a signal from an access node requesting a session for a terminal;
interacting with an online charging system which determines a quota related to an allowed service usage for the terminal; and
sending an authentication signal to said access node, wherein said authentication signal contains a session time-out parameter dependent upon the quota.

2. The AAA server of claim 1, wherein said authentication signal further contains a termination action parameter which indicates that the access node needs to either terminate the session or initiate a re-authentication request after exceeding a predetermined amount of time set by the session time-out parameter.

3. The AAA server of claim 2, wherein said processor further facilitates:
receiving a re-authentication request signal from said access node requesting that the service be extended for the terminal;
interacting with said online charging system which determines a second quota related to the remaining allowed service usage for the terminal; and
sending a second authentication signal to said access node, wherein said second authentication signal contains a session time-out parameter which is based on the second quota and a termination action parameter which indicates that the access node needs to either terminate the session or initiate a second re-authentication request after exceeding a predetermined amount of time set by the session time-out parameter.

4. The AAA server of claim 3, wherein said processor further facilitates the interacting with said online charging system by sending a signal indicating a used quota to said online charging system which then debits a service account associated with the terminal.

5. The AAA server of claim 3, wherein said processor further facilitates:
receiving an ACR signal indicating used volume/time from said access node; and
sending a CCR signal indicating the used volume/time to said online charging system.

6. The AAA server of claim 1, wherein said processor facilitates the use of signals associated with a Diameter Credit Control Application to interact with said online charging system.

7. The AAA server of claim 1, wherein said processor facilitates the use of authorization and authentication signals associated with a RADIUS/Diameter protocol to interact with said access node.

8. The AAA server of claim 1, wherein said processor facilitates the use of authorization, authentication and accounting signals associated with a RADIUS/Diameter protocol to interact with said access node.

9. The AAA server of claim 1, wherein said session time-out parameter is known as an authentication lifetime in a RADIUS/Diameter protocol.

10. The AAA server of claim 1, wherein said quota is:
a time quota;
a volume quota; or
a combined time/volume quota.

11. The AAA server of claim 10, wherein if said quota is based on said volume quota or said combined time/volume quota then said processor implements a transformation function to transform said volume quota or said combined time/volume quota into a time quota which is used in said session time-out parameter.

12. The AAA server of claim 11, wherein said transformation function is adapted to transform said volume or time/volume quota into said time quota by using a previously received and actually used volume or used time/volume.

13. A method for implementing online credit control within a communications network, said method comprising the steps of:
receiving, at an AAA server, a signal from an access node requesting a session for a terminal;
sending, from said AAA server, a request signal to an online charging system, where said online charging system determines a quota related to an allowed service usage for the terminal;
receiving, at said AAA server, a response signal containing the quota from said online charging system; and
sending, from said AAA server, an authentication signal to said access node, wherein said authentication signal contains a session time-out parameter dependent upon the quota.

14. The method of claim 13, wherein said authentication signal further contains a termination action parameter which indicates that the access node needs to either terminate the session or initiate a re-authentication request after exceeding a predetermined amount of time set by the session time-out parameter.

15. The method of claim 14, further comprising the steps of:
receiving, at said AAA server, a re-authentication request signal from said access node requesting that the service be extended for the terminal;
sending, from said AAA server, a second request signal to said online charging system, where said online charging system determines a second quota related to the remaining allowed service usage for the terminal;
receiving at said AAA server, a second response signal containing the second quota from said online charging system, and
sending, from said AAA server, a second authentication signal to said access node, wherein said second authentication signal contains a session time-out parameter which is based on the second quota and a termination action parameter which indicates that the access node needs to either terminate the session or initiate a second re-authentication request after exceeding a predetermined amount of time set by the session time-out parameter.

16. The method of claim 13, wherein:
said AAA server is co-located/integrated with said online charging system; or
said AAA server is located remote from said online charging system.

17. The method of claim 13, wherein said AAA server uses signals associated with a Diameter Credit Control Application to interact with said online charging system.

18. The method of claim 13, wherein said AAA server uses authorization and authentication signals associated with a RADIUS/Diameter protocol to interact with said access node.

19. The method of claim 13, wherein said AAA server uses authorization, authentication and accounting signals associated with a RADIUS/Diameter protocol to interact with said access node.

20. The method of claim 13, wherein said session time-out parameter is known as an authentication lifetime in a RADIUS/Diameter protocol.

21. The method of claim 13, wherein said quota is:
a time quota;
a volume quota; or
a combined time/volume quota.

22. A network for providing online credit control to a communications terminal, said network comprising an AAA server and an online charging system, wherein:
said AAA server functions as follows:
(i) receives a signal from an access node requesting a session for the communications terminal; and
(ii) sends a request signal to said online charging system;
said online charging system functions as follows:
(i) receives the request signal from said AAA server;
(ii) performs online credit control and determines a quota related to an allowed service usage for the communication terminal, and
(iii) sends a response signal containing the quota to said AAA server;
said AAA server functions as follows:
(i) receives the response signal from said online charging system; and
(ii) sends an authentication signal to said access server, wherein said authentication signal contains a session time-out parameter dependent upon the quota.

23. The network of claim 22, wherein said authentication signal further contains a termination action parameter which indicates that the access node needs to either terminate the session or initiate a re-authentication request after exceeding a certain amount of time set by the session time-out parameter.

24. The network of claim 23, wherein:
said AAA server functions as follows:
(i) receives a re-authentication request signal from said access node requesting that the service be extended for the communication terminal;
(ii) sends a second request signal to said online charging system;
said online charging system functions as follows:
(i) receives the second request signal from said AAA server;
(ii) performs online credit control and determines a second quota related to the remaining allowed service usage for the communication terminal; and
(iii) sends a second response signal containing the second quota to said AAA server;
said AAA server functions as follows:
(i) receives the second response signal from said online charging system; and
(ii) sends a second authentication signal to said access node, wherein said second authentication signal contains a session time-out parameter which is based on the second quota and a termination action parameter which indicates that said access node needs to either terminate the session or initiate a second re-authentication request after exceeding a predetermined amount of time set by the session time-out parameter.

25. The network of claim 22, wherein:
said AAA server is co-located/integrated with said online charging system; or
said AAA server is located remote from said online charging system.

26. The network of claim 22, wherein said AAA server uses signals associated with a Diameter Credit Control Application to interact with said online charging system.

27. The network of claim 22, wherein said AAA server uses authorization and authentication signals associated with a RADIUS/Diameter protocol to interact with said access node.

28. The network of claim 22, wherein said AAA server uses authorization, authentication and accounting signals associated with a RADIUS/Diameter protocol to interact with said access node.

29. The network of claim 22, wherein said session time-out parameter is known as an authentication lifetime in a RADIUS/Diameter protocol.

30. The network of claim 22, wherein said quota is:
a time quota;
a volume quota; or
a combined time/volume quota.
